(19) United States
(12) Patent Application Publication
(10) Pub. No.: US 2004/0145844 A1
(43) Pub. Date: Jul. 29, 2004

(54) Bypass circuit for the overcurrent trip of a low-voltage power circuit breaker

(76) Inventors: Henry Franke, Berlin (DE); Manfred Schiller, Berlin (DE)

Correspondence Address: HARNESS, DICKEY & PIERCE, P.L.C., P.O.BOX 8910, RESTON, VA, 20195, US

(21) Appl. No.: 10/477,699

(22) PCT Filed: Apr. 5, 2002
(86) PCT No.: PCT/DE02/01347

(30) Foreign Application Priority Data
May 14, 2001 (DE) 10125051.7

(51) Int. Cl. H02H 3/08

(52) U.S. Cl. 361/93.1

(57) ABSTRACT

According to the invention a bypass circuit (4) trips a power circuit breaker, independently of an existing electronic overcurrent trip (2), as instantaneously as possible when a short-circuit occurs. To achieve this, the bypass circuit (4) is supplied by its own current sensor (3) that is configured as a current transformer in order to charge a capacitor (C); until a threshold value circuit (5) responds. The charge of the capacitor (C) is then fed to a separate tripping magnet (F2) or to a combined tripping magnet (F3) comprising separate coils for the two tripping paths.

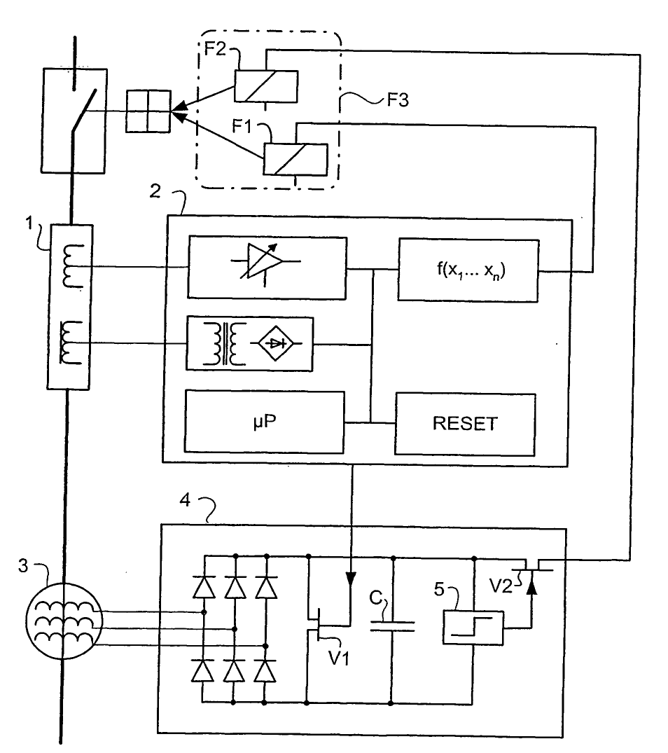

Bypass circuit for the overcurrent release of a low-voltage power breaker.

The invention relates to a bypass circuit for the electronic overcurrent release of a current-limiting low-voltage power breaker having separate current sensors for the electronic overcurrent release and for the bypass circuit as well as having a tripping magnet for releasing an energy store for the power breaker.

A bypass circuit of the type mentioned above is disclosed in EP 0 244 284 B1 (=U.S. Pat. No. 4,733,321). One main reason for using bypass circuits is the time required for an electronic overcurrent release to evaluate the current signal, in particular if said release was previously in an inactive rest state. The overcurrent release may be in an inactive rest state once the power breaker has been switched off or in a mode of operation in which the current flowing through the power breaker is so low that insufficient auxiliary energy is produced to operate the overcurrent release. The energy for operating the electronic devices in the power breaker and the overcurrent release can be taken from the power supply system itself, which is also possible without difficulty by means of the current sensor itself or, if appropriate, an additional power converter, except during a brief period (about 10 ms) after switch-on or after a rise in the current in the power supply system above the predetermined threshold value. However, even if there is sufficient auxiliary power, a microprocessor-assisted overcurrent release cannot emit a tripping command immediately in the event of a short circuit since the RESET routine of the microprocessor and the subsequent processing of the measured values produced for the current require more than 10 ms. This time requirement is too great for current-limiting power breakers. Analog and analog-electronic bypass circuits are therefore used, which make it possible for the power breaker to react substantially more quickly.

In accordance with the cited EP 0 244 284 B1, current sensors without iron cores in the manner of uniform-field converters are used for the bypass circuit. The tripping magnet is common to both types of tripping procedures and is actuated by means of a common control circuit. In this solution, as in EP 0 279 689 as well, zener diodes are used as the threshold value elements.

Besides the fact that a signal should be emitted with as little delay as possible once a threshold value for the monitored current is exceeded, a precondition for the desired rapid reaction of the power breaker to a short circuit current is that sufficient energy is available for actuating the tripping magnet. This can be ensured by the electronic devices in the power breaker being supplied by a continuously active auxiliary power source (battery etc.). However, an “autonomous” power supply is often preferred, not only for the tripping electronics but also for the tripping magnet, from the power supply system in which the power breaker is located. As a rule, the current transformers used for supplying power in this case are those which also produce the measured values for the current, or separate “power converters” are installed in the power breaker. Obviously, these devices, however, only supply auxiliary power when the current flowing through the power breaker exceeds a certain minimum value.

With the breaker having an electronic release and described in U.S. Pat. No. 4,104,601, in order to accelerate the tripping procedure in the event of short circuit currents, provision is made for the tripping magnet to be directly actuated by magnetic effects by means of which all-pole tripping can be achieved. For this purpose, the magnetic field of the main current path is caused to influence the holding magnetic field of the tripping magnet and the latter is caused to trip in the event of high overcurrents. A prerequisite of the solution is the physical proximity of the main current path to the tripping magnet, which can be achieved only in a few types of switching devices (MCCB).

The invention is based on the object of specifying a bypass circuit for the release of a low-voltage power breaker which ensures highly reliable interruption in the event of short circuits.

The object is achieved according to the invention by the features of claim 1. Expedient refinements are the subject matter of the subclaims.

As described in the claims, the current sensors provided for operating the bypass circuit are in the form of current transformers having sufficient output power to actuate a tripping magnet when a short circuit current is flowing.

The solution provides an entirely independent circuit for undelayed tripping of the breaker contacts. This means that the tripping power is provided, the response threshold is measured and conversion to a mechanical movement of the contacts takes place using means that are neither partly nor wholly a component of the normal tripping system. The provision of a separate tripping magnet gives the most favorable design for the components and the shortest tripping delay. However, an embodiment of the tripping magnet provided for the electronic overcurrent release may also be used which has a second winding for tripping by means of the bypass circuit.

The complexity of the second tripping system is surprisingly low since it merely involves detecting very high currents with a non-critical tolerance, and thus, in particular, the current transformer may have an extremely simple design. The magnetic circuit may be open, for example in the form of a rod-like core.

The evaluation circuit may have a correspondingly simple design. It comprises, for example, a rectifier, a capacitor and a threshold value circuit monitoring the state of charge of the capacitor.

During normal operation of the overcurrent release, the bypass circuit can be short-circuited. This switches it off so that it cannot trip spuriously in the event of electromagnetic interference.

The invention is described in more detail below with reference to an exemplary embodiment.

The drawing shows one phase of a three-phase overcurrent tripping system of a low-voltage power breaker having a set of current sensors 1 which is a combination of uniform-field coils and power converters, a digital-electronic overcurrent release 2, which comprises a microprocessor including a reset generator, a power supply unit, the measured signal conditioning and the tripping circuit which emits a signal to a tripping magnet F1 for the low-voltage power breaker in the event of an overcurrent being detected in a monitored power supply system.

The bypass circuit 4 is supplied by a separate current sensor 3 which is in the form of a current transformer which supplies power and has as simple a design as possible. Its cores may, for example, be magnetically open circuit (rod cores). The bypass circuit 4 comprises a bridge rectifier and a capacitor C which can be charged by the latter. A threshold value circuit 5 monitors the state of charge of the capacitor C. As soon as a sufficiently high charge voltage is reached across the capacitor C, an electronic switch V2 is closed and by this means the energy stored in the capacitor C is fed to a second tripping magnet F2. One advantage of using the separate tripping magnets F1 and F2 is that it is possible to optimally match them electrically and magnetically to the power available for tripping and thus, in particular with regard to the second tripping magnet F2, to achieve a particularly short tripping delay whilst maintaining favorable dimensions for the current sensor 3 and the components in the bypass circuit 4.

Another possibility is a common tripping magnet F3, shown in the figure by dashed-dotted lines, which has separate windings for the two tripping paths. There are thus separate circuits for the two types of tripping procedure which do, however, use a common mechanical and magnetic path.

The bypass circuit 4 thus operates completely independently of the microprocessor-assisted electronic overcurrent release 2.

In normal operating conditions, i.e. once the evaluation time of approximately 10 ms has elapsed, the bypass circuit 4 can be short-circuited by the transistor V1. It is thus inactive and cannot have a disruptive effect on the overcurrent release 2.

1. A bypass circuit (4) for the electronic overcurrent release (2) of a current-limiting low-voltage power breaker having separate current sensors (1; 3) for the electronic overcurrent release (2) and for the bypass circuit (4) as well as having a tripping magnet (F1) for releasing an energy store for the power breaker,
characterized in that
the current sensors (3) provided for operating the bypass circuit (4) are in the form of current transformers having sufficient output power to actuate a tripping magnet (F2; F3) when a short circuit current is flowing.

2. The bypass circuit as claimed in claim 1,
characterized in that
a charging circuit for a capacitor (C) as well as a threshold value circuit (5), which monitors the voltage of the capacitor (C), for allowing the capacitor (C) to be discharged to the tripping magnet (F2, F3) when there is sufficient charge are connected between the current sensors (3) of the bypass circuit (4) and the tripping magnet (F2).

3. The bypass circuit as claimed in claim 1 or 2,
characterized in that
the bypass circuit (4) contains a short-circuiting device (V1), which can be controlled by the electronic overcurrent release (2), for deactivating the bypass circuit (4) in the range of currents to be processed by the electronic overcurrent release (2).

4. The bypass circuit as claimed in one of claims 1 to 3,
characterized in that
a common tripping magnet (F3) is provided for tripping the power breaker by means of the electronic overcurrent release (2) and by means of the bypass circuit (4), and in that the tripping magnet (F3) has separate windings for the two tripping procedures.

5. The bypass circuit as claimed in one of claims 1 to 3,
characterized in that
separate tripping magnets (F1, F2) are provided for tripping the power breaker by means of the electronic overcurrent release (2) and by means of the bypass circuit (4).

6. The bypass circuit as claimed in one of the preceding claims,
characterized in that
the current sensors (3) in the form of current transformers have a magnetically open-circuit iron core.
